(19) United States
(12) Patent Application Publication
(10) Pub. No.: US 2025/0233824 A1
(43) Pub. Date: Jul. 17, 2025

(54) METHOD AND SYSTEM FOR NETWORK SLICING WITH MULTI-SIM DEVICES

(71) Applicant: Verizon Patent and Licensing Inc., Basking Ridge, NJ (US)

(72) Inventors: Samirkumar Patel, Middlesex, NJ (US); Heidi Kass, Martinsville, NJ (US)

(21) Appl. No.: 18/414,357

(22) Filed: Jan. 16, 2024

(51) Int. Cl. H04L 45/302; H04M 1/72409; H04W 76/10; H04W 88/06

(52) U.S. Cl. CPC H04L 45/306; H04M 1/72409; H04W 76/10; H04W 88/06

(57) ABSTRACT

A method, an end device, and a non-transitory computer-readable storage medium are described in relation to a multi-subscriber identification module (SIM) network slice mapping service. The multi-SIM network slice mapping service may be used by an end device with multiple SIMs. The service may include mapping a SIM to use for an end device application session and a network slice based on user equipment (UE) route selection policies (URSP) stored by the end device, a request from the end device application, setting information configured by a user, and/or a network device.

### BACKGROUND

End devices may access and use various networks, applications, and services based on certain configurations at the end devices. For example, the end device may include one or multiple subscriber profiles and/or one or multiple subscriber identification modules (SIMs) or the like.

### BRIEF DESCRIPTION OF THE DRAWINGS

FIG. 1 is a diagram illustrating an exemplary environment in which an exemplary embodiment of a multi-SIM network slice mapping service may be implemented;

FIG. 2 is a flow diagram illustrating an exemplary process of an exemplary embodiment of the multi-SIM network slice mapping service;

FIG. 3 is a flow diagram illustrating another exemplary process of an exemplary embodiment of the multi-SIM network slice mapping service;

FIG. 4 is a flow diagram illustrating still another exemplary process of an exemplary embodiment of the multi-SIM network slice mapping service;

FIG. 5A is a flow diagram illustrating yet another exemplary process of an exemplary embodiment of the multi-SIM network slice mapping service;

FIG. 5B is a diagram illustrating an exemplary graphical user interface of an exemplary embodiment of the multi-SIM network slice mapping service;

FIG. 6A is a flow diagram illustrating another exemplary process of an exemplary embodiment of the multi-SIM network slice mapping service;

FIG. 6B is a diagram illustrating another exemplary graphical user interface of an exemplary embodiment of the multi-SIM network slice mapping service; and

FIG. 7 is a diagram illustrating exemplary components of a device that may correspond to one or more of the devices illustrated and described herein.

### DETAILED DESCRIPTION

The following detailed description refers to the accompanying drawings. The same reference numbers in different drawings may identify the same or similar elements. Also, the following detailed description does not limit the invention.

A service provider, a network provider, a network operator, a wireless carrier, or another type of entity may have to manage various aspects of end devices that may support wireless access to various networks, applications, and/or other services. For example, an end device may include one or multiple (SIMs), embedded SIMs (eSIMs), Universal SIMs (USIMs), integrated SIMs (iSIMs), and/or a similar type of application, software, and/or executable (referred to herein as simply a SIM) that may enable the end device to access a network, among other things. A card may be implemented as a SIM card, an eSIM card/chip, a Universal Integrated Circuit Card (UICC), an embedded UICC (eUICC), a secure element (SE), an integrated trusted execution environment (TEE), a chip or the like (referred to herein as simply a card). The card may include hardware and may include various types of data, an application, software, an operating system (OS), and/or other types of executables that may be stored on and executed by the card, for example. The card may host a profile, which may include subscription data, security authentication and ciphering information, network configuration information (e.g., roaming files/configuration, etc.), applications (e.g., USIM, etc.), algorithms (e.g., encryption, decryption, etc.), and so forth.

An end device having multiple SIMs may be implemented as a Dual SIM Dual Standby (DSDS) end device or a Dual SIM Dual Active (DSDA) end device. For example, for the DSDS type, the two SIM cards may be active, but only one SIM card may be used for calls, messages, or data at a time. For the DSDA type, the two SIM cards may be active and both can be used for calls, messages, or data at the same time. However, for DSDS and DSDA types of end devices, the primary-configured SIM (operator) may be used for default data and voice. The other or secondary SIM may be used only when the primary SIM/connectivity does not have proper reception for an incoming call or for default Internet, or the user of the end device manually modifies the primary SIM configuration.

For network slicing, a primary SIM and a secondary SIM may each have their own respective configurations. For example, network slicing may be enabled only on the secondary SIM, which may be associated with the same or different carrier relative to the primary SIM. Alternatively, for example, the primary and secondary SIMs may each be enabled for network slicing, but each SIM may be optimized for different kinds of performance. For example, the differences in performance may relate to bitrate, latency, error rate, reliability, throughput, and/or another kind of performance metric or traffic characteristic associated with an end device application.

Currently, however, there is no mechanism for the user of the end device to or for the end device to automatically map different service types or traffic categories to different network slices that are subscribed on different SIMs or operators while using multiple SIMs except by changing the primary SIM.

According to exemplary embodiments, a multi-SIM network slice mapping service is described. According to an exemplary embodiment, the multi-SIM network slice mapping service may be implemented by an end device with two or more SIMs, as described herein. For example, the multi-SIM network slice mapping service may be implemented, in whole or in part, by an operating system of the end device, a modem of the end device, and/or a user interface of the end device that may receive and store setting information from a user, as described herein. According to an exemplary embodiment, the multi-SIM network slice mapping service may be implemented, in part by a network device, as described.

According to an exemplary embodiment, the multi-SIM network slice mapping service may include selecting from multiple SIMs, a SIM that may (optimally) support an end device application session associated with an end device application of the end device via a network slice. According to an exemplary embodiment, the multi-SIM network slice mapping service may make the selection of the SIM to use based on user equipment (UE) route selection policies (URSP) stored by the end device and/or a request from the end device application, as described herein. The end device may establish a packet data unit (PDU) session with a network device via the network slice with use of the SIM.

In view of the foregoing, the multi-SIM network slice mapping service may allow or enable network slicing on different SIMs other than the primary SIM on a multi-SIM end device. According to various exemplary embodiments, the multi-SIM network slice mapping service may allow a user of an end device or the end device to maintain multiple SIM profiles while in their normal and active states and provide optimal network slicing across the multiple SIMs and operators. The multi-SIM network slice mapping service may provide selection of which SIM to use, from among multiple SIMs, for network slicing, as described herein.

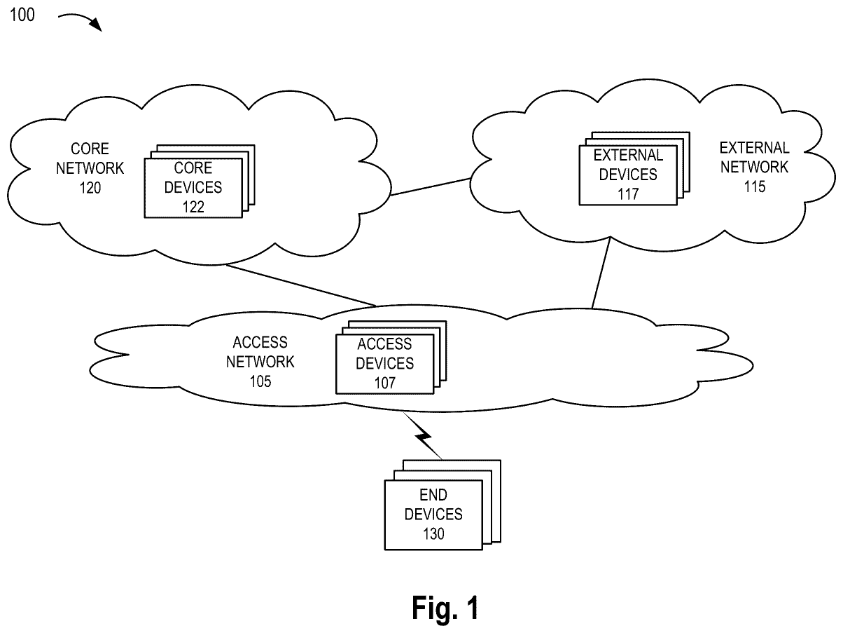

FIG. 1 is a diagram illustrating an exemplary environment 100 in which an exemplary embodiment of the multi-SIM network slice mapping service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes end devices 130 (also referred to individually and generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane, a user plane, a service plane, and/or a network management plane. Environment 100 may include other types of planes of communication. A message communicated in support of the multi-SIM network slice mapping service may use at least one of these planes of communication. Additionally, or alternatively, a message communicated in support of the multi-SIM network slice mapping service may be implemented via a connection between components within end device 130, via an application programming interface (API), or the like.

Access network 105 may include one or multiple networks of one or multiple types and technologies. For example, access network 105 may be implemented to include a Fifth Generation (5G) RAN, a future generation RAN (e.g., a Sixth Generation (6G) RAN, a Seventh Generation (7G) RAN, or a subsequent generation RAN), a centralized-RAN (C-RAN), an Open-RAN (O-RAN), and/or another type of access network. Access network 105 may include a legacy RAN (e.g., a Third Generation (3G) RAN, a Fourth Generation (4G) RAN, etc.).

Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105.

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., radio access technologies (RATs), etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. According to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced Long Term Evolution (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), or another type of wireless node (e.g., a WiFi device, a WiMax device, a hotspot device, a fixed wireless access CPE (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

External network 115 may include one or multiple networks of one or multiple types and technologies that provide an end device application service. For example, external network 115 may be implemented using one or multiple technologies including network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of end device application services. For example, the end device application service may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (IoT) (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, and/or other types of wireless and/or wired application services. External devices 117 may also include other types of network devices that support the operation of external network 115 and the provisioning of application services, such as an orchestrator, an edge manager, an operations support system (OSS), a local domain name system (DNS), registries, and/or external devices 117 that may pertain to various network-related functions (e.g., security, management, charging, billing, authentication, authorization, policy enforcement, development, etc.). External devices 117 may include non-virtual, logical, and/or physical network devices.

According to some exemplary embodiments, external devices 117 may include a network device that provides an exemplary embodiment of the multi-SIM network slice mapping service. For example, external device 117 may be implemented to include a server device that receives a communication from end device 130 and determines which SIM, from multiple SIMs, that may be eligible and/or optimal for an end device application and support a network slice and end device application session, as described herein. The server device may communicate a selection of the SIM to end device 130.

Core network 120 may include one or multiple networks of one or multiple network types and technologies. Core network 120 may include a complementary network of access network 105. For example, core network 120 may be implemented to include a 5G core network, an evolved packet core (EPC) network of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM), a unified data repository (UDR), an authentication server function (AUSF), a security anchor function (SEAF), a network exposure function (NEF), a network slice selection function (NSSF), a network repository function (NRF), a policy control function (PCF), a network data analytics function (NWDAF), a service capability exposure function (SCEF), a lifecycle management (LCM) device, a mobility management entity (MME), a packet data network (PDN) gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS).

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), and/or other combined nodes (e.g., an HSS with a UDM and/or UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

End device 130 may include a device that may have computational and communication capabilities (e.g., wireless, wired, optical, etc.). End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, or another type of UE.

End device 130 may be configured to execute various types of software (e.g., applications, programs, etc.). The number and the types of software may vary among end devices 130. For example, end device 130 may host one or multiple end device applications that may relate to various types of application services described in relation to external devices 117. For example, the end device application may pertain to IoT, extreme real-time communications, gaming, voice, video-calling, navigation, ultra-reliable communications, and so forth. The end device application may include a client-side application.

End device 130 may include “edge-aware” and/or “edge-unaware” application service clients. For purposes of description, end device 130 is not considered a network device. End device 130 may be implemented as a virtualized device in whole or in part.

According to an exemplary embodiment, end device 130 includes at least two SIMs, as described herein. For example, the SIM may be a physical SIM (pSIM), an eSIM, or another type of SIM, as described herein. According to various exemplary embodiments, end device 130 may be of a DSDS type, a DSDA type, or a type that involves three or more SIMs (e.g., a Tri-SIM or Triple SIM type, a Quad-SIM type, and so forth). End device 130 may also be pre-provisioned (e.g., on a card) with the URSP information.

According to an exemplary embodiment, end device 130 provides an exemplary embodiment of the multi-SIM network slice mapping service, as described herein. According to an exemplary embodiment, end device 130 may include an operating system and a modem that includes logic of an exemplary embodiment of the multi-SIM network slice mapping service. For example, the operating system may be implemented as Windows®, Linux®, Android®, iOS®, proprietary, or the like. The operating system may include a kernel or a library that includes logic of an exemplary embodiment of the multi-SIM network slice mapping service, as described herein.

According to some exemplary embodiments, the operating system may include mapping a request from the end device application, as described herein, to a traffic descriptor of the URSP information. For example, traffic descriptors may include parameters, such as application descriptors, IP descriptors, domain descriptors, non-IP descriptors, data network name (DNN), connection capabilities.

The modem may be implemented in or as a modem, a baseband chip, URSP logic, or another element that may enforce URSP rules and/or manage access and/or establishment of network connections by end device 130 with a network (e.g., access network 105, external network 115, core network 120). The modem may include a processor and memory and/or storage.

According to some exemplary embodiments, the modem may map route selection descriptors to traffic descriptors. Route selection descriptors may include route selection descriptor precedence, SSC mode selection, network slice selection (e.g., a single value or a list of S-NSSAI(s)), DNN selection, PDU selection type, non-seamless offload indication, access type preference, and multi-access preference. According to some exemplary embodiments, the modem may assign 5G QoS Identifiers (5QIs). The modem may use standardized 5QI values (e.g., associated with 3GPP or another standards body) and/or non-standardized values (e.g., 5QI values from 128-254) that may be operator-specific configurations. End device 130 may establish a PDU session and QoS flows via the network slice(s) with external network 115/external device 117.

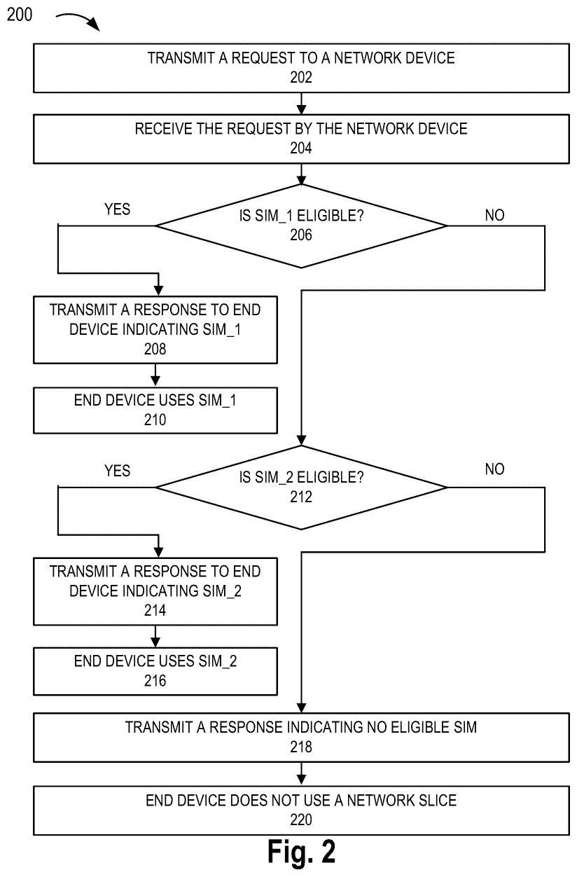

FIG. 2 is a flow diagram illustrating an exemplary process 200 of an exemplary embodiment of the multi-SIM network slice mapping service. According to an exemplary embodiment, end device 130 and a network device may perform steps of process 200. According to an exemplary implementation, a processor may execute software to perform a step (in whole or in part) of process 200, as described herein. Alternatively, a step (in whole or in part) may be performed by execution of only hardware. According to some exemplary embodiments, the network device may be implemented as external device 117 or core device 122. According to an exemplary embodiment, the network device may be a server device. For example, the network device may be implemented as an entitlement server, an Internet Protocol (IP) server, a device management server, or a similar type of platform.

In block 202, end device 130 may transmit a request to the network device. For example, end device 130 or an end device application may generate the request in response to a triggering event. For example, the triggering event may be the launching of the end device application, or a condition in which the end device application needs to establish a network connection. According to an exemplary embodiment, the request may include a unique identifier of end device 130 (e.g., a universally unique identifier (UUID), an International Mobile Subscriber Identity (IMSI), an International Mobile Equipment Identity (IMEI), or the like) and a (unique) identifier of the end device application. The end device application or end device 130 may include an application programming interface (API) or the like to communicate with the network device, as described herein.

In block 204, the network device may receive the request. According to some exemplary embodiments, the network device and end device 130 may perform an authentication and/or authorization procedure. According to such embodiments, assume the procedure is successful. In block 206, the network device may determine whether a first SIM is eligible. For example, the network device may store mapping information. The mapping information may include identifiers of end devices 130, application identifiers, and SIM information (e.g., SIM identifiers, SIM data, etc.). The network device may use the identifiers included in the request as keys to the mapping information that enables the network device to identify whether a primary SIM, a default SIM, or any SIM from amongst multiple SIMs is eligible and/or optimal for an end device application session associated with the (unique) identifier of the end device application.

When the network device determines that the first SIM is eligible (block 206-YES), the network device may transmit a response indicating the first SIM to end device 130 (block 208). For example, the network device may generate and transmit the response that includes an identifier of the first SIM. In block 210, end device 130 may use the first SIM. For example, an end device application may communicate to the operating system to establish a PDU session with external device 117 via a network slice based on the first SIM.

When the network device determines that the first SIM is not eligible (block 206-NO), the network device may determine whether a second SIM is eligible (block 212). For example, the network device may use the identifiers included in the request as keys to the mapping information that enables the network device to identify whether a secondary SIM, a non-default SIM, or any other SIM from amongst the multiple SIMs not previously evaluated is eligible and/or optimal for an end device application session associated with the application identifier.

When the network device determines that the second SIM is eligible (block 212-YES), the network device may transmit a response indicating the second SIM to end device 130 (block 214). For example, the network device may generate and transmit the response that includes an identifier of the second SIM. In block 216, end device 130 may use the second SIM. For example, the end device application may communicate with the operating system to establish a PDU session with external device 117 via a network slice based on the second SIM.

When the network device determines that the second SIM is not eligible (block 212-NO), the network device may transmit a response indicating that no SIM is eligible to end device 130 (block 218). In block 220, end device 130 may not use a network slice. For example, end device 130 may establish an end device application session without use of a network slice. By way of further example, the end device application may communicate with the operating system to establish a network connection with external device 117. The operating system may select any SIM, a default SIM, or a SIM based on some other end device configuration.

FIG. 2 illustrates an exemplary process 200 of the multi-SIM network slice mapping service, however, according to other exemplary embodiments, the multi-SIM network slice mapping service may perform additional operations, fewer operations, and/or different operations than those illustrated and described in relation to FIG. 2. For example, according to other exemplary processes in which there are more than two SIMs, process 200 may include whether a third SIM, a fourth SIM, and so forth are eligible in a manner similar to the steps described and illustrated in relation to the first and second SIMs.

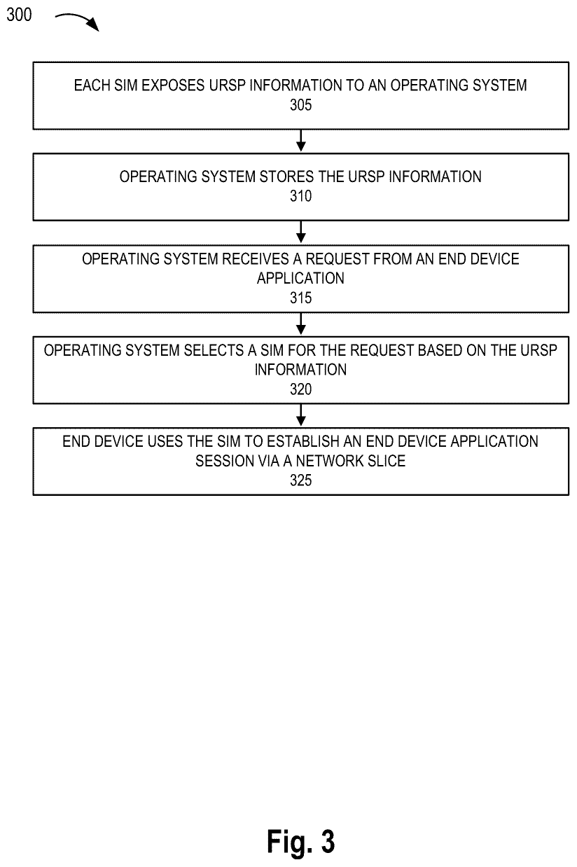

FIG. 3 is a flow diagram illustrating an exemplary process 300 of an exemplary embodiment of the multi-SIM network slice mapping service. According to an exemplary embodiment, end device 130 may perform steps of process 300. According to an exemplary implementation, a processor may execute software to perform a step (in whole or in part) of process 300, as described herein. Alternatively, a step (in whole or in part) may be performed by execution of only hardware.

In block 305, each SIM may expose its URSP information to the operating system of end device 130. For example, each SIM may be configured with URSP rules that it is permitted or eligible to request. The URSP rules may include a traffic descriptor or the traffic descriptor and a route selection descriptor. The SIM may be configured with an API or the like to expose the URSP rules to the operating system.

In block 310, the operating system may store the URSP information. In block 315, the operating system may receive a request from an end device application. For example, the end device application may generate and transmit the request to the operating system based on a triggering event (e.g., being launched, needing to establish a network connection, needing to transmit and/or receive data, etc.). The request may include a network slice request, a request to establish a PDU session, a request to establish a network connection, and/or the like, for example. The request may include an identifier of the end device application. The request may include application information of the end device application. For example, the application information may include application traffic characteristics information, connection capabilities codes or values, connection types, or similar types of information that may enable the operating system to map the request to the URSP information.

In block 320, the operating system may select the SIM for use based on the URSP information. For example, the operating system may select the SIM for use in support of the request based on the URSP information and the end device application.

In block 325, end device 130 may use the SIM to establish an end device application session via the network slice with external device 117.

FIG. 3 illustrates an exemplary process 300 of the multi-SIM network slice mapping service, however, according to other exemplary embodiments, the multi-SIM network slice mapping service may perform additional operations, fewer operations, and/or different operations than those illustrated and described in relation to FIG. 3.

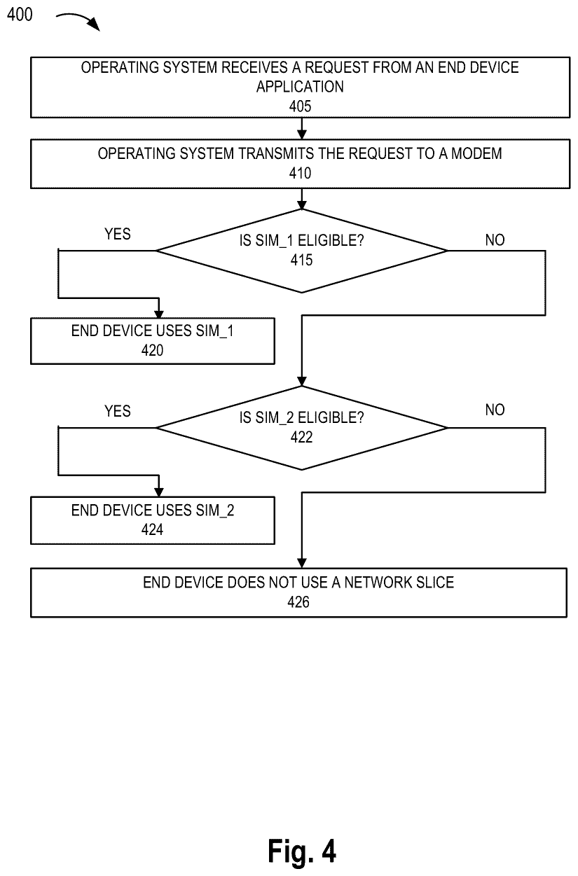

FIG. 4 is a flow diagram illustrating an exemplary process 400 of an exemplary embodiment of the multi-SIM network slice mapping service. According to an exemplary embodiment, end device 130 may perform steps of process 400. According to an exemplary implementation, a processor may execute software to perform a step (in whole or in part) of process 400, as described herein. Alternatively, a step (in whole or in part) may be performed by execution of only hardware.

In block 405, the operating system may receive a request from an end device application. For example, the end device application may generate and transmit the request to the operating system based on a triggering event (e.g., being launched, needing to establish a network connection, needing to transmit and/or receive data, etc.). The request may include a network slice request, a request to establish a PDU session, a request to establish a network connection, and/or the like, for example. The request may include an identifier of the end device application. The request may include application information (e.g., application traffic characteristics, connection capabilities codes/values, or the like) of the end device application that may enable a mapping to URSP information.

In block 410, the operating system may send the request to a modem. For example, the operating system may determine a traffic descriptor based on the request. The operating system may generate and transmit a request, which may include the traffic descriptor, the identifier of the end device application, to the modem, for example.

In block 415, the modem may determine whether a first SIM is eligible. For example, in response to receiving the request from the operating system, the modem may evaluate whether the first SIM is eligible for use based on the request and URSP information, which may include a route selection descriptor (e.g., a network slice), as described herein.

When the modem determines that the first SIM is eligible (block 415-YES), end device 130 may use the first SIM (block 420). For example, end device 130 may establish a PDU session for the end device application with external device 117 via the network slice and use of the first SIM.

When the modem determines that the first SIM is not eligible (block 415-NO), the modem may determine whether a second SIM is eligible (block 422). For example, the modem may evaluate whether the second SIM is eligible for use based on the request and URSP information, which may include a route selection descriptor (e.g., a network slice), as described herein.

When the modem determines that the second SIM is eligible (block 422-YES), end device 130 may use the second SIM (block 424). For example, end device 130 may establish a PDU session for the end device application with external device 117 via the network slice and use of the second SIM.

When the modem determines that the second SIM is not eligible (block 422-NO), end device 130 may not use a network slice (block 426). For example, end device 130 may establish a network connection with external device 117 without a network slice. The modem may select any SIM, a default SIM, or a SIM based on some other end device configuration.

FIG. 4 illustrates an exemplary process 400 of the multi-SIM network slice mapping service, however, according to other exemplary embodiments, the multi-SIM network slice mapping service may perform additional operations, fewer operations, and/or different operations than those illustrated and described in relation to FIG. 4. For example, according to other exemplary processes in which there are more than two SIMs, process 400 may include whether a third SIM, a fourth SIM, and so forth are eligible in a manner similar to the steps described and illustrated in relation to the first and second SIMs.

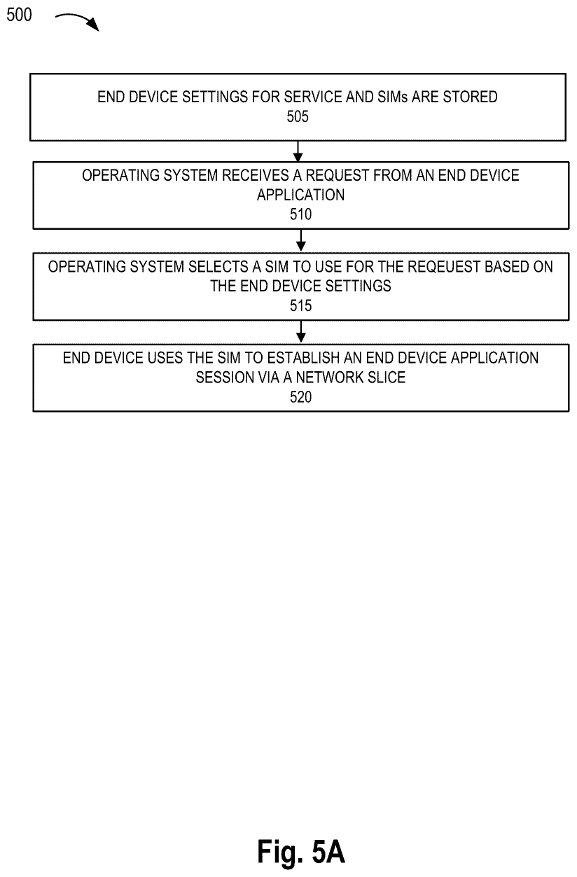

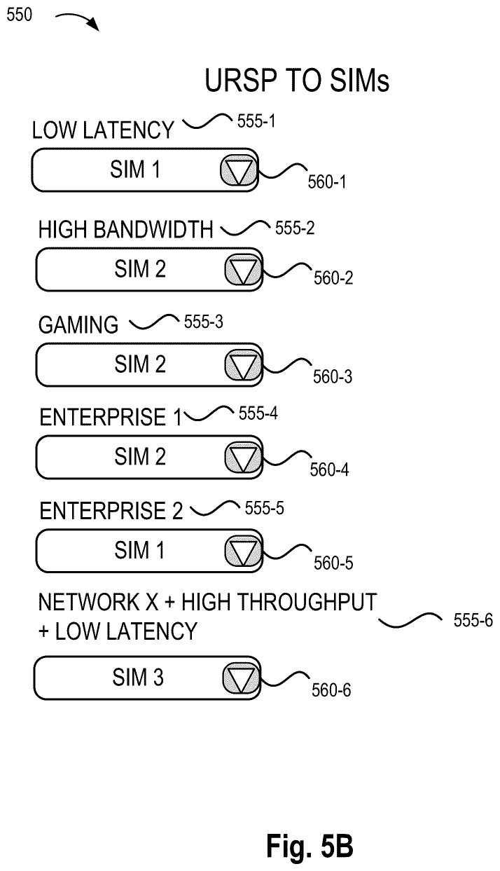

FIG. 5A is a flow diagram illustrating an exemplary process 500 of an exemplary embodiment of the multi-SIM network slice mapping service. According to an exemplary embodiment, end device 130 may perform steps of process 500. According to an exemplary implementation, a processor may execute software to perform a step (in whole or in part) of process 500, as described herein. Alternatively, a step (in whole or in part) may be performed by execution of only hardware.

In block 505, end device settings for services and SIMs are stored. For example, end device 130 may include a GUI that enables a user to configure mappings between a traffic descriptor and a SIM, a route selection descriptor and a SIM, a URSP rule (e.g., which may include both a traffic descriptor and a route selection descriptor), or another form of service and a SIM.

As illustrated in FIG. 5B, an exemplary GUI 550 is depicted. GUI 550 may include URSP instances 555-1 through 555-5 (also referred to collectively as URSP instances 555, and individually or generally as URSP instance 555), and SIM selections 560-1 through 560-6 (also referred to collectively as SIM selections 560, and individually or generally as SIM selection 560). The number and type of URSP instances 555 are exemplary. For example, low latency, high bandwidth, and gaming may be considered exemplary traffic descriptors; enterprise 1 and enterprise 2 may be considered exemplary route selection descriptors; and network X+high throughput+low latency may be considered an exemplary traffic descriptor and route selection descriptor. Additionally, the number of SIM selections 560 is exemplary. Further, end device 130 may include more than two SIMs, as described herein.

Referring back to FIG. 5A, in block 510, the operating system may receive a request from an end device application. For example, the request may be a network slice request, a PDU session establishment request, a network connection request, and/or the like. The request may include an identifier of the end device application. The request may include other types of application information that enables mapping to the stored URSP information, as described herein.

In block 515, the operating system may select the SIM to use for the request based on the end device settings. For example, the operating system may match or correlate the end device application to the stored URSP information, in whole or in part (e.g., traffic descriptor, traffic descriptor and route descriptor, etc.) based on the request, and determine and/or select the appropriate URSP instance 555 and corresponding SIM selection 560.

In block 520, end device 130 may use the SIM to establish an end device application session with an external device 117 via a network slice. For example, end device 130 may select the appropriate route selection descriptor, which may indicate the network slice.

FIG. 5A illustrates an exemplary process 500 of the multi-SIM network slice mapping service, however, according to other exemplary embodiments, the multi-SIM network slice mapping service may perform additional operations, fewer operations, and/or different operations than those illustrated and described in relation to FIG. 5A.

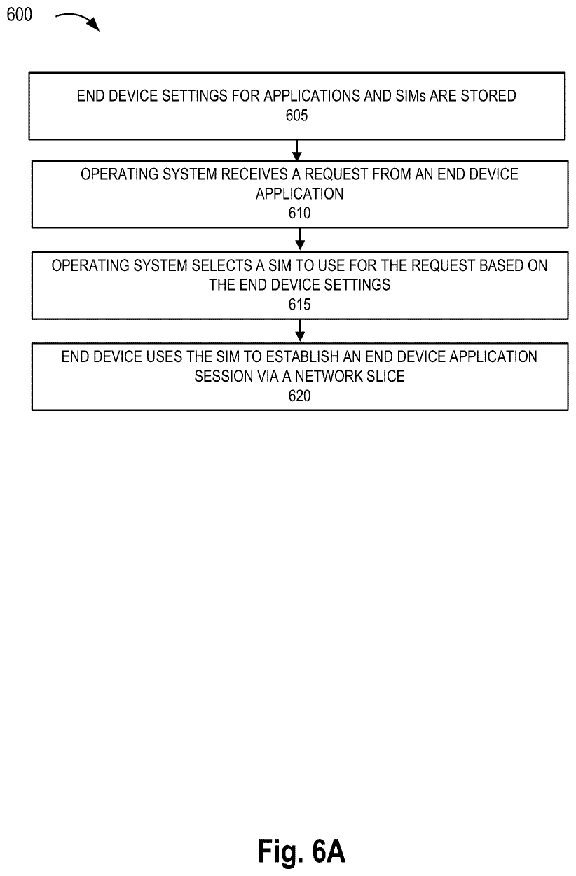

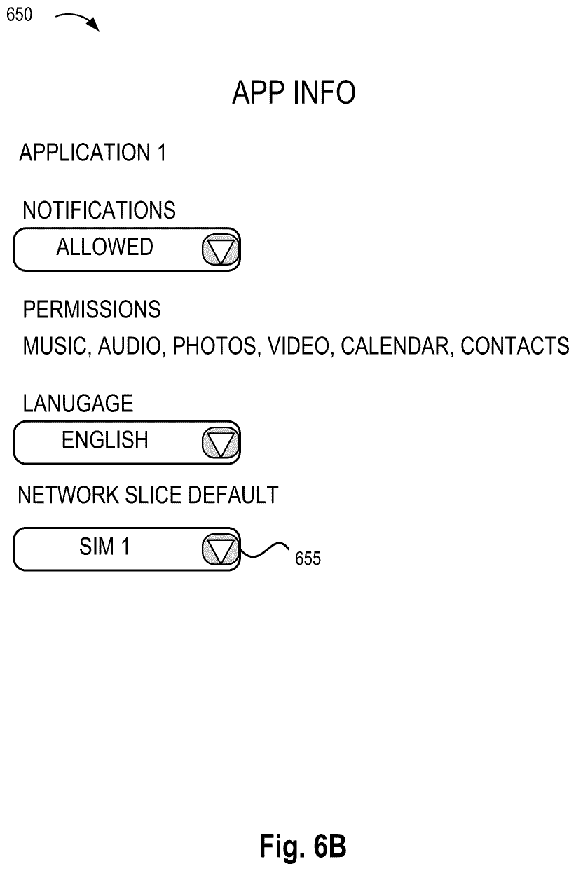

FIG. 6A is a flow diagram illustrating an exemplary process 600 of an exemplary embodiment of the multi-SIM network slice mapping service. According to an exemplary embodiment, end device 130 may perform steps of process 600. According to an exemplary implementation, a processor may execute software to perform a step (in whole or in part) of process 600, as described herein. Alternatively, a step (in whole or in part) may be performed by execution of only hardware.

In block 605, end device settings for applications and SIMs are stored. For example, end device 130 may include a GUI that enables a user to configure mappings between an application and a SIM.

As illustrated in FIG. 6B, an exemplary GUI 650 is depicted. GUI 650 may include a SIM selection 655. SIM selection 655 may allow a user to map a SIM to the end device application. This information may be stored as an end device setting. End device 130 may include a similar GUI for all or a subset of end device applications hosted on end device 130.

Referring back to FIG. 6A, in block 610, the operating system may receive a request from an end device application. For example, the request may be a network slice request, a PDU session establishment request, a network connection request, and/or the like. The request may include an identifier of the end device application. The request may include other application information that enables a mapping to the stored URSP information, as described herein.

In block 615, the operating system may select the SIM to use for the request based on the end device setting. For example, the operating system may determine the SIM selection 655 for the end device application based on the request (e.g., identifier of the end device application).

In block 620, end device 130 may use the SIM to establish an end device application session with an external device 117 via a network slice. For example, end device 130 may select the appropriate route selection descriptor, which may indicate the network slice.

FIG. 6A illustrates an exemplary process 600 of the multi-SIM network slice mapping service, however, according to other exemplary embodiments, the multi-SIM network slice mapping service may perform additional operations, fewer operations, and/or different operations than those illustrated and described in relation to FIG. 6A.

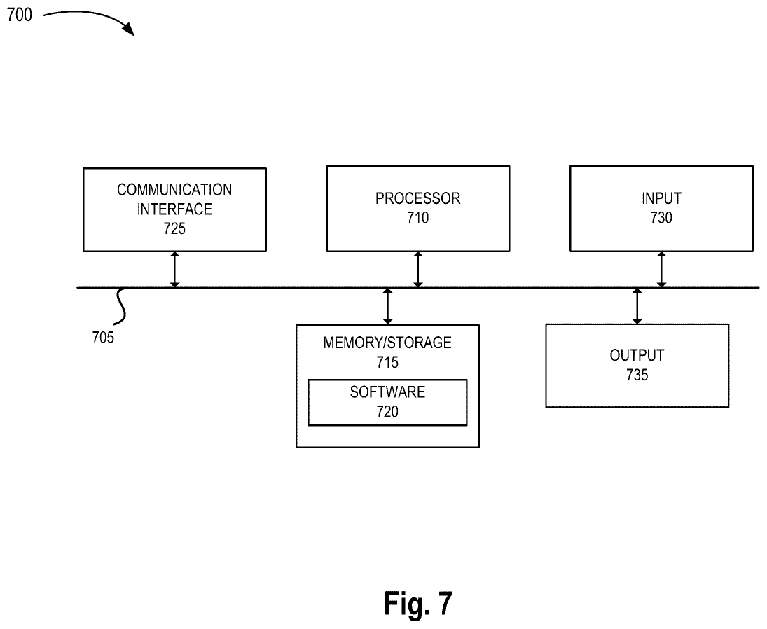

FIG. 7 is a diagram illustrating exemplary components of a device 700 that may be included in one or more of the devices described herein. For example, device 700 may correspond to access device 107, external device 117, core device 122, end device 130, and/or other types of devices, as described herein. As illustrated in FIG. 7, device 700 includes a bus 705, a processor 710, a memory/storage 715 that stores software 720, a communication interface 725, an input 730, and an output 735. According to other embodiments, device 700 may include fewer components, additional components, different components, and/or a different arrangement of components than those illustrated in FIG. 7 and described herein.

Bus 705 includes a path that permits communication among the components of device 700. For example, bus 705 may include a system bus, an address bus, a data bus, and/or a control bus. Bus 705 may also include bus drivers, bus arbiters, bus interfaces, clocks, and so forth.

Processor 710 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 710 may be implemented as hardware (e.g., a microprocessor, etc.), a combination of hardware and software (e.g., a SoC, an ASIC, etc.), may include one or multiple memories (e.g., cache, etc.), etc.

Processor 710 may control the overall operation, or a portion of operation(s) performed by device 700. Processor 710 may perform one or multiple operations based on an operating system and/or various applications or computer programs (e.g., software 720). Processor 710 may access instructions from memory/storage 715, from other components of device 700, and/or from a source external to device 700 (e.g., a network, another device, etc.). Processor 710 may perform an operation and/or a process based on various techniques including, for example, multithreading, parallel processing, pipelining, interleaving, learning, model-based, etc.

Memory/storage 715 includes one or multiple memories and/or one or multiple other types of storage mediums. For example, memory/storage 715 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 715 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 715 may be external to and/or removable from device 700, such as, for example, a Universal Serial Bus (USB) memory stick, a dongle, a hard disk, mass storage, off-line storage, or some other type of storing medium. Memory/storage 715 may store data, software, and/or instructions related to the operation of device 700.

Software 720 includes an application or a program that provides a function and/or a process. As an example, with reference to end device 130, software 720 may include an application that, when executed by processor 710, provides a function and/or a process of the multi-SIM network slice mapping service, as described herein. Software 720 may also include firmware, middleware, microcode, hardware description language (HDL), and/or another form of instruction. Software 720 may also be virtualized. Software 720 may further include an operating system (e.g., Windows, Linux, Android, proprietary, etc.), such as operating system 204. Software 720 may include applications 202.

Communication interface 725 permits device 700 to communicate with other devices, networks, systems, and/or the like. Communication interface 725 includes one or multiple wireless interfaces, optical interfaces, and/or wired interfaces. For example, communication interface 725 may include one or multiple transmitters and receivers, or transceivers. Communication interface 725 may operate according to a protocol stack and a communication standard. Communication interface 725 may include modem 206.

Input 730 permits an input into device 700. For example, input 730 may include a keyboard, a mouse, a display, a touchscreen, a touchless screen, a button, a switch, an input port, speech recognition logic, and/or some other type of visual, auditory, tactile, affective, olfactory, etc., input component. Output 735 permits an output from device 700. For example, output 735 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 700 may be implemented in the same manner. For example, device 700 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 700 may be configured to perform a process and/or a function, as described herein, in response to processor 710 executing software 720 stored by memory/storage 715. By way of example, instructions may be read into memory/storage 715 from another memory/storage 715 (not shown) or read from another device (not shown) via communication interface 725. The instructions stored by memory/storage 715 cause processor 710 to perform a function, an operation, or a process described herein. Alternatively, for example, according to other implementations, device 700 may be configured to perform a function, an operation, or a process described herein based on the execution of hardware (processor 710, etc.).

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 2, 3, 4, 5A, and 6A, the order of the blocks may be modified according to other embodiments. Further, non-dependent blocks may be performed in parallel. Additionally, other processes described in this description may be modified and/or non-dependent operations may be performed in parallel. Also, with reference to the processes described herein, a component of end device 130, such as an operating system and/or a modem, are exemplary.

Embodiments described herein may be implemented in many different forms of software executed by hardware. For example, a process or a function may be implemented as “logic,” a “component,” or an “element.” The logic, the component, or the element, may include, for example, hardware (e.g., processor 710, etc.), or a combination of hardware and software (e.g., software 720).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 710) of a device. A non-transitory storage medium includes one or more of the storage mediums described in relation to memory/storage 715. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
storing, by an end device including subscriber identification modules (SIMs), setting information configured by a user of the end device that maps a SIM of the SIMs to an end device application or a user equipment route selection policy (URSP);
receiving, by the end device, a request from the end device application;
selecting, by the end device based on the setting information, the SIM to use for the request; and
establishing, by the end device with use of the SIM, an end device application session with a network device.

2. The method of claim 1, further comprising:
receiving, via a user interface of the end device, an input from the user indicating the SIM to map to the end device application.

3. The method of claim 1, further comprising:
receiving, via a user interface of the end device, an input from the user indicating the SIM to map to a traffic descriptor.

4. The method of claim 1, further comprising:
receiving, via a user interface of the end device, an input from the user indicating the SIM to map to a route selection descriptor.

5. The method of claim 1, further comprising:
receiving, via a user interface of the end device, an input from the user indicating the SIM to map to a traffic descriptor and a route selection descriptor.

6. The method of claim 1, wherein the request includes an identifier of the end device application and information pertaining to the end device application.

7. The method of claim 1, further comprising:
selecting, by the end device based on the request, the setting information.

8. The method of claim 1, further comprising:
correlating, by the end device, the request to user equipment route selection policies including traffic descriptors and route selection descriptors.

9. An end device comprising:
subscriber identification modules (SIMs); and
a processor, wherein the processor is configured to:
store setting information configured by a user of the end device that maps a SIM of the SIMs to an end device application or a user equipment route selection policy (URSP);
receive a request from the end device application;
select, based on the setting information, the SIM to use for the request; and
establish, with use of the SIM, an end device application session with a network device.

10. The end device of claim 9, wherein the processor is further configured to:
receive, via a user interface of the end device, an input from the user indicating the SIM to map to the end device application.

11. The end device of claim 9, wherein the processor is further configured to:
receive, via a user interface of the end device, an input from the user indicating the SIM to map to a traffic descriptor.

12. The end device of claim 9, wherein the processor is further configured to:
receive, via a user interface of the end device, an input from the user indicating the SIM to map to a route selection descriptor.

13. The end device of claim 9, wherein the processor is further configured to:
receive, via a user interface of the end device, an input from the user indicating the SIM to map to a traffic descriptor and a route selection descriptor.

14. The end device of claim 9, wherein the request includes an identifier of the end device application and information pertaining to the end device application.

15. The end device of claim 9, wherein the processor is further configured to:
select, based on the request, the setting information.

16. The end device of claim 9, wherein the processor is further configured to:
correlate the request to user equipment route selection policies including traffic descriptors and route selection descriptors.

17. A non-transitory computer-readable storage medium storing instructions executable by a processor of an end device including subscriber identification modules (SIMs), wherein the instructions are configured to:
store setting information configured by a user of the end device that maps a SIM of the SIMs to an end device application or a user equipment route selection policy (URSP);
receive a request from the end device application;
select, based on the setting information, the SIM to use for the request; and
establish, with use of the SIM, an end device application session with a network device.

18. The non-transitory computer-readable storage medium of claim 17, wherein the instructions are further configured to:
receive, via a user interface of the end device, an input from the user indicating the SIM to map to the end device application.

19. The non-transitory computer-readable storage medium of claim 17, wherein the instructions are further configured to:
receive, via a user interface of the end device, an input from the user indicating the SIM to map to a traffic descriptor.

20. The non-transitory computer-readable storage medium of claim 17, wherein the instructions are further configured to:
receive, via a user interface of the end device, an input from the user indicating the SIM to map to a route selection descriptor.
